(19) United States
(12) Patent Application Publication
(10) Pub. No.: US 2021/0365232 A1
(43) Pub. Date: Nov. 25, 2021

(54) ELECTRONIC APPARATUS AND CONTROL METHOD THEREOF

(71) Applicant: SAMSUNG ELECTRONICS CO., LTD., Suwon-si (KR)

(72) Inventors: Kyoungshin JIN, Suwon-si (KR); Dongwook KIM, Suwon-si (KR); Minsup KIM, Suwon-si (KR); Jaeyong KIM, Suwon-si (KR); Hyuna SONG, Suwon-si (KR); Sungho CHAE, Suwon-si (KR)

(73) Assignee: SAMSUNG ELECTRONICS CO., LTD., Suwon-si (KR)

(21) Appl. No.: 17/398,667

(22) Filed: Aug. 10, 2021

Related U.S. Application Data
(63) Continuation of application No. PCT/KR2021/000012, filed on Jan. 4, 2021.
(60) Provisional application No. 62/957,390, filed on Jan. 6, 2020.

(30) Foreign Application Priority Data
Apr. 17, 2020 (KR) 10-2020-0046962

(51) Int. Cl. G06F 3/14; G06F 3/147

(52) U.S. Cl. CPC G06F 3/1462; G06F 3/1423; G06F 3/147

(57) ABSTRACT

An electronic device is provided. The electronic device includes an interface; a sensor; and a processor configured to: identify whether a pattern of a signal generated by the sensor corresponds to any of a plurality of reference patterns, based on the pattern corresponding to a reference pattern from among the plurality of reference patterns, identify an external apparatus corresponding to the reference pattern, and based on the pattern of the signal corresponding to the reference pattern, perform establish a connection between the external apparatus and the electronic apparatus through the interface.

### CROSS-REFERENCE TO RELATED APPLICATION(S)

This application is a continuation of International Application No. PCT/KR2021/000012, filed on Jan. 4, 2021, which claims priority to U.S. Provisional Application No. 62/957,390, filed on Jan. 6, 2020, in the U.S. Patent and Trademark Office, and Korean Patent Application No. 10-2020-0046962, filed on Apr. 17, 2020, in the Korean Intellectual Property Office, the disclosures of which are incorporated by reference herein in their entireties.

### BACKGROUND

### Field

The disclosure relates to an electronic apparatus, which transmits and receives contents through a connection with another electronic apparatus, and a control method thereof.

### Description of Related Art

Recently, electronic apparatus have an increased number of functions, including transmitting and receiving contents through connections with other electronic apparatuses. In this regard, there is a need for technologies to facilitate connections between the electronic apparatuses.

### SUMMARY

Provided is an electronic apparatus, which can efficiently recognize an external apparatus, and a control method thereof.

According to embodiments of the disclosure, an electronic apparatus includes: an interface; a sensor; and a processor configured to: identify whether a pattern of a signal generated by the sensor corresponds to any of a plurality of reference patterns, based on the pattern corresponding to a reference pattern from among the plurality of reference patterns, identify an external apparatus corresponding to the reference pattern, and based on the pattern of the signal corresponding to the reference pattern, perform establish a connection between the external apparatus and the electronic apparatus through the interface.

The processor may be further configured to, based on a plurality of models learned to identify characteristics of the plurality of reference patterns different from each other, identify whether the pattern of the signal corresponds to the reference pattern.

The processor may be further configured to identify whether the pattern of the signal corresponds to the reference pattern based on similarities between the pattern of the signal and normalized characteristics of reference patterns of the plurality of models.

The processor may be further configured to generate a model of a new reference pattern corresponding to the pattern of the signal based on identifying the pattern of the signal does not correspond to any of the plurality of reference patterns.

The processor may be further configured to: control the electronic apparatus to receive information about the plurality of models from a server, and identify whether the pattern of the signal corresponds to the reference pattern based on the information received about the plurality of models.

The plurality of reference patterns may respectively correspond to a plurality of external apparatuses, and the processor may be further configured to: identify the external apparatus corresponding to the pattern of the signal from among the plurality of external apparatuses, and transmit content corresponding to the external apparatus.

The plurality of reference patterns may respectively correspond to a plurality of users, and the processor may be further configured to: identify a user corresponding to the pattern of the signal from among the plurality of users, and transmit content corresponding to the user to the external apparatus.

The plurality of reference patterns may include a first plurality of reference patterns corresponding to user events and a second plurality of reference patterns corresponding to noise, and the processor may be further configured to: identify whether the pattern of the signal corresponds to any of the first plurality of reference patterns, and based on the pattern of the signal not corresponding to any of the first plurality of reference patterns, identify whether the pattern of the signal corresponds to any of the second plurality of reference patterns.

The processor may be further configured to, based on a plurality of models learned to identify characteristics of the second plurality of reference patterns different from each other, identify whether the pattern of the signal corresponds to the second plurality of reference patterns.

The processor may be further configured to, based on identifying the pattern of the signal does not correspond to any of the first plurality of reference patterns and does not correspond to any of the second plurality of reference patterns, add a model of a new reference pattern corresponding to the pattern of the signal.

Each of the plurality of reference patterns may have characteristics different from each other indicative of a user from among a plurality of users.

The processor may be further configured to control transmission of a content to the external apparatus through the connection.

The processor may be further configured to identify the content from among a plurality of contents based on the pattern of the signal.

According to embodiments of the disclosure, a control method of an electronic apparatus includes: identifying whether a pattern of a signal generated by a sensor of the electronic apparatus corresponds to any of a plurality of reference patterns; based on the pattern corresponding to a reference pattern from among the plurality of reference patterns, identifying an external apparatus corresponding to the reference pattern; and based on the pattern of the signal corresponding to the reference pattern, establishing a connection between the external apparatus and the electronic apparatus through an interface of the electronic apparatus.

The identifying whether the pattern of the signal corresponds to any of the plurality of reference patterns may include, identifying whether the pattern of the signal corresponds to any of the plurality of reference patterns based on a plurality of models learned to identify characteristics of the plurality of reference patterns which differ from each other.

The identifying whether the pattern of the signal corresponds to any of the plurality of reference patterns may include identifying whether the pattern of the signal corresponds to any of the plurality of reference patterns based on similarities between the pattern of the signal and normalized characteristics of reference patterns of the plurality of models.

The control method may further include adding a model of a new reference pattern corresponding to the pattern of the signal based on the pattern of the signal not corresponding to any of the plurality of reference patterns.

According to embodiments of the disclosure, a non-transitory computer readable recording medium has embodied thereon a program, which when executed by a processor of an electronic apparatus causes the electronic apparatus to execute a method that includes: identifying whether a pattern of a signal generated by a sensor of the electronic apparatus corresponds to any of a plurality of reference patterns; based on the pattern corresponding to a reference pattern from among the plurality of reference patterns, identifying an external apparatus corresponding to the reference pattern; and based on the pattern of the signal corresponding to the reference pattern, establishing a connection between the external apparatus and the electronic apparatus through an interface of the electronic apparatus.

According to embodiments of the disclosure, an electronic apparatus includes: an interface; a sensor; a memory configured to store a first content and a second content; and a processor configured to: identify whether a pattern of a signal generated by the sensor corresponds to any of a plurality of reference patterns, based on the pattern corresponding to a first reference pattern from among the plurality of reference patterns, transmit the first content to a first external apparatus through the interface, and based on the pattern corresponding to a second reference pattern from among the plurality of reference patterns, transmit the second content to a second external apparatus through the interface.

The processor may be further configured to: based on the pattern corresponding to the first reference pattern, establish a connection with the first external apparatus through the interface, and based on the pattern corresponding to the second reference pattern, establish the connection with the second external apparatus through the interface.

Each of the plurality of reference patterns may indicate a reference intensity and a reference number of peaks.

The processor may be further configured to compare a number of peaks in the signal generated by the sensor with the reference number of peaks in each of the plurality of reference patterns to identify whether the pattern of the signal corresponds to any of the plurality of reference patterns.

The processor may be further configured to compare an intensity of the signal generated by the sensor with the reference intensity of the plurality of reference patterns to identify whether the pattern of the signal corresponds to any of the plurality of reference patterns.

According to embodiments of the disclosure, an electronic apparatus includes: a display panel; an interface; a sensor; and a processor configured to: identify whether a pattern of a signal generated by the sensor corresponds to any of a plurality of reference patterns, based on the pattern corresponding to a first reference pattern from among the plurality of reference patterns, establish a connection with a first external apparatus through the interface and control the display panel to display first information received from the first external apparatus through the interface, and based on the pattern corresponding to a second reference pattern from among the plurality of reference patterns, establish the connection with a second external apparatus through the interface and control the display panel to display second information received from the second external apparatus through the interface.

The processor may be further configured to perform a screen mirroring operation based on the first information received from the first external apparatus or the second information received from the second external apparatus through the interface.

According to embodiments of the disclosure, the electronic device may identify detected signal based on different models reflecting a variety of situations, and increase reliability about recognition of a user event.

### BRIEF DESCRIPTION OF THE DRAWINGS

The above and other aspects, features and advantages of certain embodiments of the present disclosure will be more apparent from the following description taken in conjunction with the accompanying drawings, in which:

FIG. 1 is a view showing an operation of an electronic apparatus according to an embodiment;

FIG. 2 is a block diagram of an electronic apparatus according to an embodiment;

FIG. 3 is a flow chart showing an operation of an electronic apparatus according to an embodiment;

FIG. 4 is a view showing an operation of an electronic apparatus based on user tendency according to an embodiment;

FIG. 5 is a view showing patterns of a signal according to an embodiment;

FIG. 6 is a view showing an operation of an electronic apparatus according to an embodiment;

FIG. 7 is a view showing an operation flow of an electronic apparatus according to an embodiment;

FIG. 8 is a view showing an operation of an electronic apparatus according to an embodiment;

FIG. 9 is a view showing an operation of an electronic apparatus according to an embodiment; and

FIG. 10 is a flow chart showing an operation of an electronic apparatus according to an embodiment.

### DETAILED DESCRIPTION

Embodiments of the disclosure will be described in detail with reference to the accompanying drawings. In the drawings, the same reference numbers or signs refer to components that perform substantially the same function, and the size of each component in the drawings may be exaggerated for clarity. The technical idea and the core configuration and operation are not limited only to the configuration or operation described in the following examples. In the disclosure, if it is determined that a detailed description of the known technology or configuration related to the disclosure may unnecessarily obscure the subject matter of the disclosure, the detailed description thereof will be omitted.

As used herein, the terms “1st” or “first” and “2nd” or “second” may use corresponding component regardless of importance or order and are used to distinguish a component from another without limiting the components. The terms “comprise,” “include,” “have,” etc. do not preclude the presence or addition of one or more other features, numbers, steps, operations, elements, components or combination thereof. In addition, a “module,” a “unit” or a “portion” may perform at least one function or operation, be achieved by hardware, software or a combination of hardware and software, and be achieved by being integrated into at least one module. Further, expressions such as “at least one of a, b or c” indicate only a, only b, only c, both a and b, both a and c, both b and c, all of a, b, and c, or variations thereof.

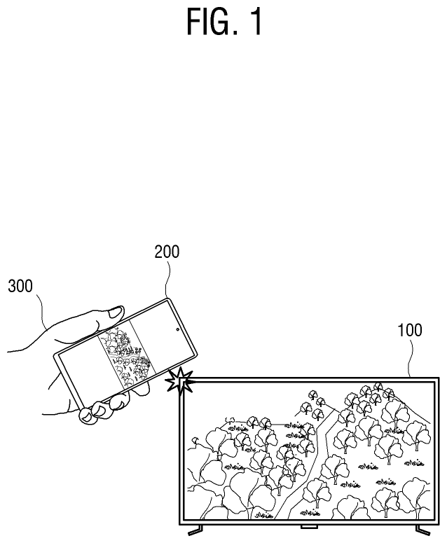

FIG. 1 is a view showing a view showing an operation of an electronic apparatus according to an embodiment.

FIG. 1 shows an electronic apparatus 100 and an external apparatus 200. Here, the electronic apparatus 100 and the external apparatus 200 may each include a display apparatus, which can display an image. For an example, the electronic apparatus 100 and the external apparatus 200 may be a television (TV), a computer, a smartphone, a tablet computer, a portable media player, a wearable device, a video wall, an electronic picture frame, or other electronic apparatus.

As shown in FIG. 1, a user 300 may make a tap motion (i.e., a tap gesture), which brings the external apparatus 200 into contact with the electronic apparatus 100. The tap motion may be a user event to establish a connection between the electronic apparatus 100 and the external apparatus 200. Thus, the tap motion may be a simple and intuitive method which connects the two apparatuses. However, embodiments are not limited to the tap motion, and various other motions or operations, such as a gesture or touch, a voice recognition, etc., may be used to establish a connection between two apparatuses. According to an embodiment, because the connection of the two apparatuses may be used for transmitting and receiving a content between the two apparatuses. Thus, the tap motion may be a user event corresponding to a transmission command of the content.

According to an embodiment, the electronic apparatus may include a sensor 170. The sensor 170 may detect the user event, such as the tap motion or the like, and the electronic apparatus 100 may use various technologies to identify the external apparatus 200 based on the detected user event. For example, based on the user event, the electronic apparatus 100 may search for a signal of peripheral apparatus through a low-power communication technology such as Bluetooth low energy (BLE). The electronic apparatus 100 may transmit information to the peripheral apparatus confirming the user event has occurred. If the electronic apparatus 100 transmits information confirming whether the user event has occurred in the searched peripheral apparatus to the external apparatus 200, the external apparatus 200, which has detected the same user event, may transmit information confirming the user event to the electronic apparatus 100. Finally, based on whether the information obtained through the sensor 170 corresponds to information obtained by the external apparatus 200 through a sensor thereof, a processor 180 of the electronic apparatus 100 may identify the external apparatus 200 corresponding to the user event. If the electronic apparatus 100 identifies the external apparatus 200, the electronic apparatus 100 may transmit or receive the content to or from the external apparatus 200.

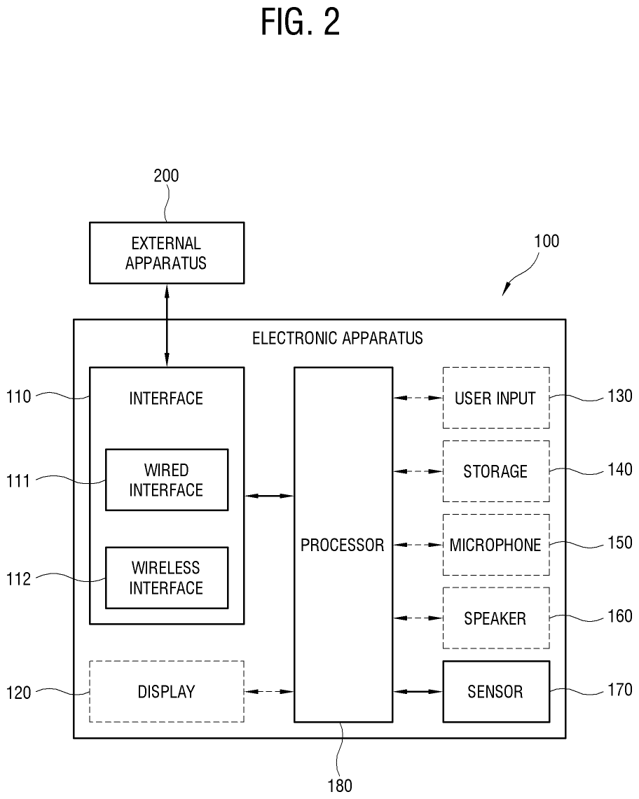

FIG. 2 is a block diagram of an electronic apparatus according to an embodiment.

As shown in FIG. 2, the electronic apparatus 100 may include an interface 110. The interface 110 may include a wired interface 111. The wired interface 111 includes a connector or port to which an antenna capable of receiving broadcast signals according to broadcasting standards, such as terrestrial broadcasting and satellite broadcasting, or/and a cable capable of receiving broadcast signals according to cable broadcasting standard may be connected. As another example, the electronic apparatus 100 may include an antenna capable of receiving broadcast signals built therein. The wired interface 111 may include a connector or port according to transmission standard of at least one among video or audio, such as High-Definition Multimedia Interface (HDMI), DisplayPort (DP), Digital Visual Interface (DVI), Thunderbolt, composite video, component video, super video, SCART or the like. The wired interface 111 may include a connector or port according to universal data transmission standard, such as Universal Serial Bus (USB) or the like. The wired interface 111 may include a connector or port to which an optical cable may be connected according to optical transmission standard. The wired interface 111 may include a connector or port to which an external microphone or an external audio device having a microphone is connected and which is capable of receiving or inputting audio signals from an audio device. The wired interface 111 may include a connector or port to which an audio device, such as a headset, an earphone, an external speaker and the like, is connected and which is capable of receiving or inputting audio signals to the audio device. The wired interface 111 may include a connector or port according to network transmission standard, such as Ethernet or the like. For example, the wired interface 111 may be implemented as Local Area Network (LAN) card or the like, which is wired to a router or a gateway.

The wired interface 111 may be wired in a 1:1 or 1:N (here, N is a natural number) manner with an external apparatus or an external display apparatus, such as a set-top box, an optical media reproducing apparatus and the like, a speaker, a server and so on via the connector or port, and may thereby transmit and receive audio/video signals therebetween. The wired interface 111 may include a connector or port, which separately transmit the audio/video signals.

According to an embodiment, the wired interface 111 is embedded in the electronic device 100, but embodiments are not limited thereto and the wired interface 111 may be also implemented as a dongle or module to be attached to or detached from the connector of the electronic device 100.

The interface 110 may include a wireless interface 112. The wireless interface 112 may communicate with the electronic device 100 according to various wireless communication standards. For example, the wireless interface 112 may communicate with the electronic device 100 using radio frequency (RF), Zigbee, Bluetooth, Wi-Fi, ultra-wideband (UWB), near-field communication (NFC), or other wireless communication method. The wireless interface 112 may be implemented as a wireless communication module for performing wireless communication with an access point (AP) according to Wi-Fi methods, a wireless communication module for performing 1:1 direct wireless communication, such as Bluetooth or the like, and so on. The wireless interface 112 may wirelessly communicate with a server on the network, thereby transmitting and receiving data packets to and from the server. The wireless interface 112 may include an infrared (IR) transmitter and/or an IR receiver, which can transmit and/or receive IR signals according to IR communication standard. The wireless interface 112 may receive or a remote control signal from a remote controller or other external apparatuses, or transmit or output the remote control signal to the remote controller or the other external apparatuses, through the IR receiver and/or the IR transmitter. As another example, the electronic device 100 may transmit and receive the remote control signal to and from the remote controller or the other external apparatuses through wireless interfaces 112 of different communication standards, such as Wi-Fi, Bluetooth and so on.

The electronic apparatus 100 may further include a tuner configured to tune broadcast video/audio signals received through the interface 110. The tuner may tune the received broadcast signals according to channels.

The electronic apparatus 100 may include a display 120. The display 120 includes a display panel, which can display an image on a screen. The display panel is provided with a light receiving structure, such as a liquid crystal, or a spontaneous emission structure, such as an organic light emitting diode (OLED). The display 120 may include an additional construction according to the structure of the display panel. For example, if the display panel is a liquid crystal type, the display 120 may include a liquid crystal display panel, a backlight configured to supply light to the liquid crystal display panel, and a panel driving substrate configured to drive the liquid crystal display panel.

The electronic apparatus 100 may include a user input 130. The user input 130 includes a circuit related to various types of input interfaces, which are provided to receive user input. The user input 130 may be configured in many different forms according to kinds of the electronic device 100. As an example, the user input 130 may include a mechanical or electronic button, an interface configured to receive input from a remote controller separated from the electronic apparatus 100, a touch pad, an interface configured to receive input from an external apparatus connected with the electronic device 100, a touch screen installed on the display 120 of the electronic device 100 and so on.

The electronic apparatus 100 may include a storage 140. The storage 140 stores digitalized data. The storage 140 includes a non-volatile storage in which data can be stored regardless of whether or not power is provided, and a volatile memory, which loads data to be processed by a processor 180 and which loses data stored therein if power is not provided. The non-volatile storage may include a flash-memory, a hard-disc drive (HDD), a solid-state drive (SSD), a read only memory (ROM) and so on and the volatile memory may include a buffer, a random access memory (RAM) and so on.

The electronic apparatus 100 may include a microphone 150. The microphone 150 may collect sounds of an external environment including user voices. The microphone 150 transmits signals corresponding to the collected sounds to the processor 180. The electronic apparatus 100 may have the microphone 150 to collect the user voices, or may receive voice signals from an external apparatus, such as a remote controller having the microphone, a smartphone and the like. The external apparatus may have a remote control application installed therein to control the electronic apparatus 100 or to perform a function, such as a voice recognition or the like. If the remote control application is installed in the external apparatus, the external apparatus may receive the user voices, and transmit and receive data to and from the electronic apparatus 100 and control the electronic apparatus using Wi-Fi/Bluetooth or infrared. Thus, the electronic apparatus 100 may be provided with a plurality of interfaces 110, which can communicate according to different communication methods.

The electronic apparatus 100 may include a speaker 160. The speaker 160 outputs sounds based on audio data processed by the processor. The speaker 160 may include a unit speaker provided to correspond to audio data of any one audio channel, or a plurality of unit speakers provided to correspond to audio data of a plurality of audio channels. As another example, the speaker 160 may be provided separately from the electronic apparatus 100. In this case, the electronic apparatus 100 may transmit the audio data to the speaker 160 through the interface 110.

The electronic apparatus 100 may include a sensor 170. The sensor 170 may detect or sense a state of the electronic apparatus 100 or a state around the electronic apparatus 100, and transmit information about the detected state to the processor 180. The sensor 170 may include at least one of a magnet sensor, an acceleration sensor, a temperature/humidity sensor, an infrared sensor, a gyroscope sensor, a position sensor (for example, a Global Positioning System (GPS) sensor), a barometric pressure sensor, a proximity sensor, a RGB sensor (or illuminance sensor), but embodiments are not limited thereto. The processor 180 may identify taps based on data provided by the sensor. For example, the storage 140 may store sensing values or characteristics that are indicative of taps between the electronic apparatus 100 and the external apparatus 200. Later, if a user event is detected, the processor 180 may identify whether the user event is a tap based on whether the detected sensing value corresponds to the stored sensing values or characteristics.

The electronic apparatus 100 includes the processor 180. The processor 180 includes at least one hardware processor, which is implemented as a central processing unit (CPU), a chipset, a buffer, a circuit and/or so on, mounted on a printed circuit board. The processor may be implemented as a system on chip (SOC) according to design methods. The processor 180 may include circuits to implement various modules corresponding to various processes, such as a demultiplexer, a decoder, a scaler, an audio digital signal processor (DSP), an amplifier and so on. Here, some or all of these modules may be implemented as the SOC. For example, circuits related to image processing, such as the demultiplexer, the decoder, the scaler and the like, may be implemented as an image processing SOC, and the audio DSP may be implemented as a chipset separate from the SOC.

The microphone 150 may generate a voice signal corresponding to a user voice. The processor 180 may convert the obtained voice signal into voice data. Here, the voice data may be text data obtained through a speech-to-text (STT) processing process, which converts the voice signal into the text data. The processor 180 may identify a command represented by the voice data and perform an operation according to the identified command. Both the voice data processing process and the command-identifying and performing process may be performed in the electronic apparatus 100. However, embodiments are not limited thereto and at least some of the processes may be performed by at least one server, which is communicably connected to the electronic device 100 through the network.

The processor 180 according to an embodiment may call at least one command from among commands of a software stored in a storage medium such as the memory 140, and execute the called at least one command. Thus, the electronic apparatus 100 and the like, may perform at least one function according to the called at least one command. The at least one command may include at least one code generated by a compiler or at least one code executable by an interpreter. The storage medium readable by the machine may be provided in a form of a non-transitory storage medium. Here, the “non-transitory storage medium” is a tangible device and indicates only that it does not include signals (for example, electromagnetic waves), and this term do not distinguish between a case where data is semi-permanently stored in the storage medium and a case where data is temporarily stored therein.

The processor 180 may identify whether a user event occurs based on whether a pattern of a signal detected through the sensor corresponds to any one reference pattern from among a plurality of reference patterns having different characteristics according to a user tendency generating the user event. Based on the signal corresponding to the reference pattern, the processor 180 may determine the user event has occurred, and control a transmission operation of transmitting a content corresponding to the user event to the external apparatus from the electronic apparatus through the interface. Here, at least some among a data analysis, a processing, and a result information generation for performing the transmission operation of the content may be performed by using at least one of a machine learning algorithm, a neural network algorithm, or a deep learning algorithm as a rule based or artificial intelligence (Al) algorithm.

As an example, the processor 180 may perform a function of a learning block and a function of a recognition block. The learning block may perform a function of generating a learned neural network and the recognition block may perform a function of recognizing (or, deducing, predicting, estimating and determining) data using the learned neural network. The learning block may generate or update the neural network. To generate the neural network, the learning block may obtain learning data. As an example, the learning block may obtain the learning data from the storage 140 or the outside. The learning data may be data using for learning the neural network, and teach the neural network using data that performed the operations described above as the learning data.

Prior to teaching the neural network using the learning data, the learning block may perform a preprocessing operation with respect to the obtained learning data, or select data to be used in learning among a plurality of learning data. As an example, to process in a form of data adapted to learning, the learning block may process the learning data in a predetermined format, filter the learning data, or add/remove noise into/from the learning data. The learning block may generate neural network set up to perform the operations described above using the preprocessed learning data.

The learned neural network may be configured as a plurality of neural networks (or layers). Nodes of the plurality of neural networks have weight values, and the plurality of neural network may be connected each other, so that an output value of one neural network is used as an input value of the other neural network. The neural networks may include, for example, models, such as convolutional neural network (CNN), deep neural network (DNN), recurrent neural network (RNN), restricted Boltzmann machine (RBM), deep belief network (DBN), bidirectional recurrent deep neural network (BRDNN) and deep Q-network.

To perform the operations described above, the recognition block may obtain target data. The target data may be obtained from the storage 140 or the outside. The target data may be data, which becomes a recognition target for the neural network. Prior to applying the target data to the learned neural network, the recognition block may perform a preprocessing operation with respect to the obtained target data, or select data to be used in recognizing target data among a plurality of data. As an example, to process in a form of data adapted to recognizing, the recognition block may process the target data in a predetermined format, filter the target data, or add/remove noise into/from the target data. The recognition block may apply the preprocessed target data to the neural network, thereby obtaining an output value outputted from the neural network. The recognition block may obtain a probability value or a reliability value along with the output value.

As an example, a control method of the electronic apparatus 100 according to an embodiment may be provided in a computer program product. The computer program product may include the commands of the software, which are executed by the processor 180, as described above. The computer program product may be traded as goods between the seller and the buyer. The computer program product may be distributed in a form of a storage medium (for example, CD-ROM) readable by the machine, or distributed (for example, downloaded or uploaded) directly on-line through an application store (for example, play store™) or between two user device (for example, smart phones). In case of the on-line distribution, at least some of the computer program product may be momentarily stored or transitory generated in a storage medium readable by the machine, such as a memory in a server of a manufacturer, a server of application store, or a relay server.

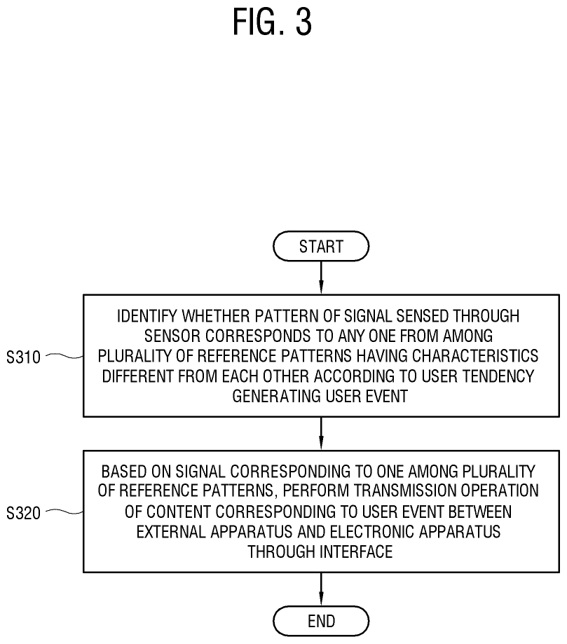

FIG. 3 is a flow chart showing an operation of the electronic apparatus according to an embodiment.

The processor 180 may identify whether a pattern of a signal detected through the sensor 170 corresponds to any one from among a plurality of reference patterns having different characteristics that vary according to a user tendency generating a user event (S310).

As shown in FIG. 1, if the user 300 makes a tap motion, which brings the external apparatus 200 into contact with the electronic apparatus 100, the electronic apparatus 100 may generate a signal through the sensor 170. Here, characteristics of the generated signal may be unique to the user 300 or the external apparatus 200, which comes in physical contact with the electronic apparatus 100. For example, the generated signal may change in a pattern that corresponds to a material or a weight of the external apparatus 200, a material of a casing of an external apparatus 200 covered with the casing, a strength in force of the user 300, a speed of the tap motion, a number of the tap motion, a tendency having according to users 300 when performing the tap motion and so on. The pattern of the detected signal indicates a characteristic of the signal, and may indicate a size, a frequency, a waveform or the like of the signal. In the disclosure, various factors, which cause the signal to vary in different pattern as described above, are all called a user tendency.

Thus, even though the pattern of the detected signal is changed according to the user tendency, the processor 180 may identify whether the corresponding signal is a signal corresponding to the user event. The processor 180 may compare the pattern of the signal corresponding to the user event with the plurality of reference patterns to identify the signal corresponding to the user event. Here, the reference patterns are patterns which serve as a criterion for identifying whether the pattern of the detected signal is the pattern of the signal corresponding to the user event. Therefore, the processor 180 may identify whether the pattern of the detected signal corresponds to any one reference pattern from among a plurality of reference patterns, which represents the user event.

However, if a reference pattern is fixed, there is a difficulty in identifying the patterns of the signal changed according to the user tendency. Accordingly, even though the pattern of the detected signal is changed according to the user tendency, to identify whether the corresponding signal is a valid signal connecting between electronic apparatuses, the plurality of reference patterns having different characteristics according to the user tendency are required.

As described above, the plurality of reference patterns have characteristics that differ according to the various factors related to the external apparatus 200 or the user 300, i.e., the user tendency. The plurality of reference patterns may be stored in the storage 140 in advance, or received from the outside, such as the server or the like, through the interface 110. Also, the plurality of reference patterns may be learned by at least some among data analysis, processing, and result information generation about a plurality of patterns of detected signal, which carries out by using at least one of a machine learning algorithm, a neural network algorithm, or a deep learning algorithm as a rule based or artificial intelligence (Al) algorithm. In this case, the reference patterns may not only be learned according to the user tendency to recognize patterns of signal generated by valid tap motions of the user, but also to identify signals corresponding to noises to be described later. The plurality of learned reference patterns may be stored in the storage 140 in advance, or new reference patterns learned and generated by the processor 180 may also be in the storage 140.

Based on a signal corresponding to one among the plurality of reference patterns, the processor 180 may perform a transmission operation of a content corresponding to the user event between the external apparatus 200 and the electronic apparatus through the interface 110 (S320). The content includes all usable contents, such as photographs, video data, audio data and so on. Also, the transmission operation of the content includes transmitting the content to the external apparatus 200 or receiving the content from the external apparatus 200, but is not limited to any one among them.

According to an embodiment, because the patterns of the signal differ from each other according to the user tendency, they may be compared with the plurality of reference patterns on which those are reflected, thereby increasing recognition rate of the user event.

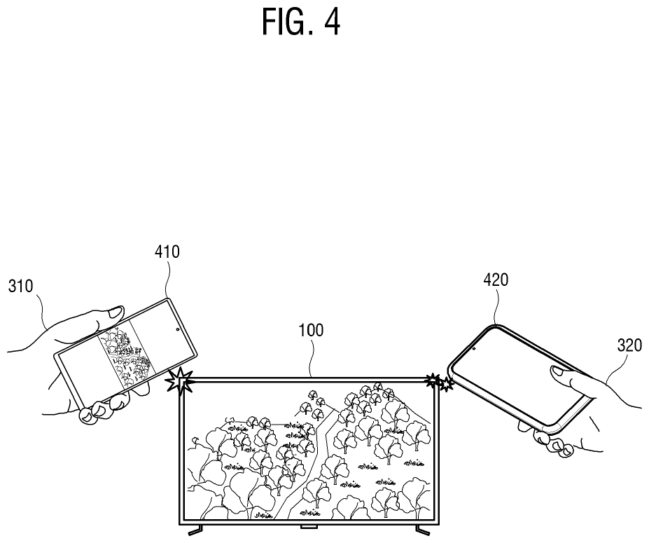

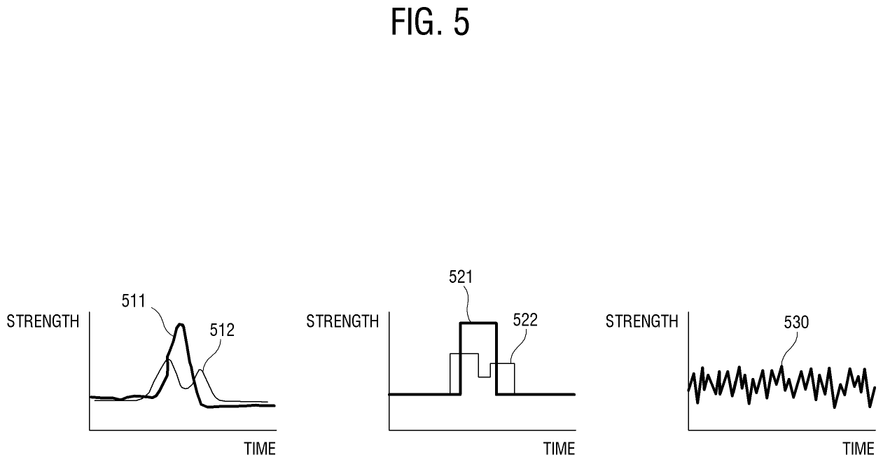

FIG. 4 is a view showing an operation of the electronic apparatus based on the user tendency according to an embodiment, and FIG. 5 is a view showing the patterns of the signal according to an embodiment.

FIG. 4 shows an image in which a first user 310 using a first external apparatus 410 and a second user 320 using a second external apparatus 420 perform tap motions. In FIG. 5 a pattern 511 of signal generated by the tap motion of the first user 310 using the first external apparatus 410 of FIG. 4, a pattern 512 of signal generated by the tap motion of the second user 320 using the second external apparatus 420, reference pattern 521 and 522 corresponding to the patterns 411 and 512, and a noise pattern 530. In FIG. 5, the respective patterns of signal are shown as a strength according to a time, but embodiments are not limited thereto.

As explained above, the patterns of signal may have characteristics different from each other according to the user tendency. For example, the first user 310, as an adult, performs the tap motion once to the electronic apparatus 100 by using the first external apparatus 410 with which a casing is not covered, and the second user 320, as a child, performs the tap motion twice to the electronic apparatus 100 by using the second external apparatus 420 with which a casing is covered.

A strength of the tap motion may be different according to users. For example, the force of the first user is stronger than the force of the second user. Thus, the tap motion of the first user will be stronger in strength than that of the second user. Also, the strength of the tap motion may be different according to materials of the first external apparatus 410 and the second external apparatus 420. For example, in case of the first external apparatus 410 which is not covered with the casing, when the first external apparatus 410 comes in physical contact with the electronic apparatus 100, outer surfaces of the first external apparatus 410 and the electronic apparatus 100 may be in contact. On the other hand, in case of the second external apparatus 420 with which the casing, for example, made of rubber material is covered, because the casing is composed of material softer than the outer surface of the second external apparatus 420, the tap motion of the second external apparatus 420 may be lower in strength than that of the first external apparatus 410, which comes in contact with the electronic apparatus 100 as it is. Like this, the strength or the like of the tap motion may be different according to the users and/or the external apparatuses, and there may be a variety of cases.

Accordingly, in FIG. 5, the pattern 511 of the signal generated by the first user 310 is stronger in intensity than the pattern 512 of the signal generated by the second user 320 because the first external apparatus 410 does not have a case and the first user 310 is an adult, whereas the second external apparatus 420 has a rubber case and the second user 320 is a child. Moreover, the pattern 511 has only one peak because the first user 310 carries out the tap motion once. The pattern 512 of the signal generated by the second user 320 is weaker in intensity than the pattern 511, but has two small peaks because the second user 320 carries out the tap motion twice. Here, the second user 320 may intentionally carry out the tap motion twice. Also, the second user 320 may carry out the tap motion in such a manner that she/he performs the second tap motion weaker than the first tap motion. To distinguish such tapping motions, the drawing may be exaggeratedly shown. Like this, the patterns of the signal may be different even according to a tendency of the tap motions of the user.

The processor 180 may identify whether the pattern of signal detected through the sensor 170 corresponds to any one reference pattern among the plurality of reference patterns. As described above, the reference patterns may be obtained through various ways, and the reference patterns 521 and 522 corresponding to the patterns 511 and 512 of the signals of the first and the second users 310 and 320, respectively, have already been obtained. The reference patterns 521 and 522 are not exactly the same as the patterns 511 and 512 of the respective signals, but have, for example, forms that normalize patterns of signals. However, in an embodiment, the processor is operated to compares signals in a form of normalizing the reference patterns, and the patterns of the signals of the first and the second users to identify whether or not the user event occurs, but in another embodiment, for example, in case of learning the reference patterns corresponding to the respective users by artificial intelligence, if occurrence frequencies of the tap motions of the users increase and thus learned data is sufficiently accumulated, it is possible for the processor 180 to directly compare signals of the reference patterns and the patterns of the signals of the first and the second users without normalizing.

According to an embodiment, the processor 180 may use the different reference patterns according to the user tendency to identify whether the user event occurs, thereby increasing recognition rate of the user event.

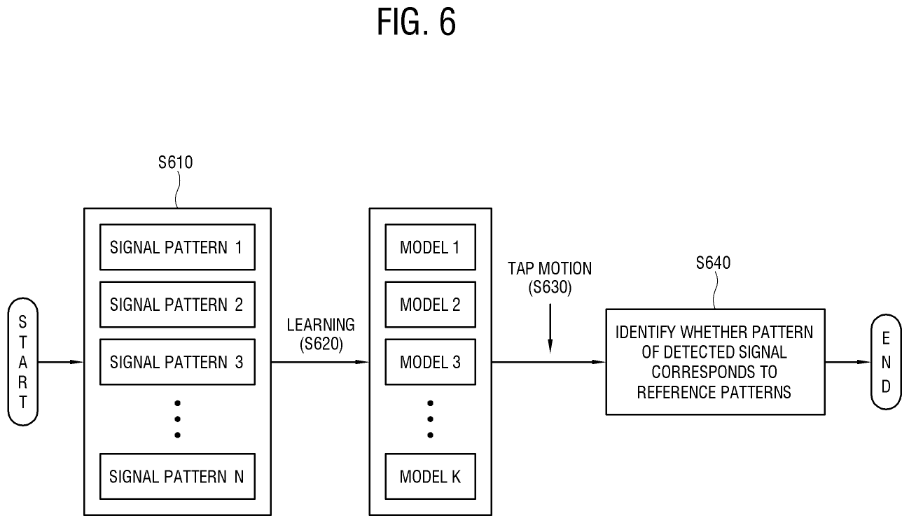

FIG. 6 is a view showing an operation of the electronic apparatus 100 according to an embodiment. The processor 180 according to an embodiment may identify whether the patterns of the signals correspond to the reference patterns based on a plurality of models learned to identify different characteristics of the plurality of reference patterns. The plurality of models is respectively set to correspond to values (hereinafter, referred to as normalized values), which normalize corresponding reference patterns by parameters used in identifying whether the patterns of the signals correspond to the reference patterns. Thus, by using models in which parameters are set to correspond to normalized values of certain reference patterns, patterns of signals having corresponding normalized values may be recognized.

According to an embodiment, the processor 180 may separately detect a plurality of patterns of detected signals (a signal pattern 1, a signal pattern 2, . . . , a signal pattern n) generated different from each other according to the user tendency, through the sensor 170 (S610). The processor 180 may identify a characteristic of a pattern of detected signal, and recognize the patterns of detected signal based on a plurality of models (a model 1, a model 2, . . . , a model k) learned to correspond to a plurality of normalized values classified according to expected characteristic of the plurality of patterns of the signals. A process, which learns the models, is carried out in a design stage or a manufacturing stage of the electronic apparatus 100. Data or information of the learned models may be stored in the storage 140 in advance or received from the server or the like through the interface 110, but embodiments are not limited to any one among those and may be implemented, for example, by a combination thereof. As another example, the processor 180 may directly learn the patterns of the detected signals to generate new models corresponding thereto. This will be described in more details below.

If a tap motion is generated by the user (S630), the processor 180 may identify whether a pattern of a signal detected through the sensor 170 corresponds to the reference patterns based on the plurality of models prepared in advance, or directly learned or received from the outside (S640). At this time, more particularly, the processor 180 may identify whether the pattern of the detected signal corresponds to the reference patterns based on similarities between the pattern of the detected signal and the normalized values of the reference patterns of the respective models.

According to an embodiment, the processor 180 may more precisely identify the pattern of the signal based on the plurality of learned models, thereby increasing reliability about recognition of the user event.

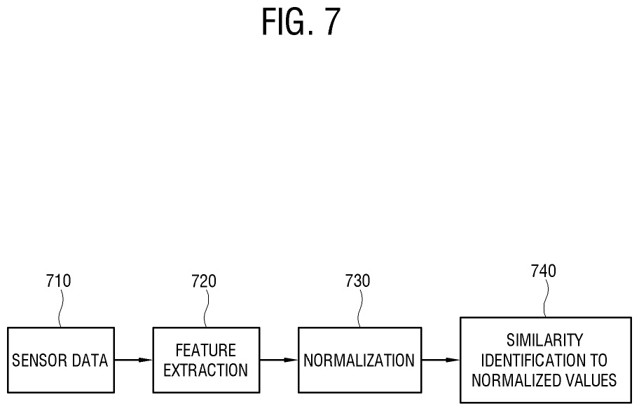

FIG. 7 is a view showing an operation flow of the electronic apparatus according to an embodiment.

According to an embodiment, the processor 180 may extract a feature from sensor data (710), i.e., the pattern of the signal detected through the sensor 170 (720). For example, the extracted feature may be extracted as below by applying a function to impulses detected in x, y and z axes of the sensor 170.

For example, the extracted feature may be the absolute value of an impulse detected in an x-axis, abs(diff_x), the absolute value of an impulse detected in a y-axis, abs(diff_y), the absolute value of an impulse detected in a a-axis, abs(diff_z), or the difference of the impulse from a normal impulse, f_diff_norm. [91] The processor 180 may perform a normalization with respect to the extracted feature (730), and identify, for example, similarities between normalized values of the impulses of the detected signal and normalized values of the reference patterns of the respective models to which parameters are learned and set to correspond to expected impulses (740). According to this, the processor 180 may identify a user event of a detected tap motion by using any one model similar to the detected tap motion from among the plurality of models learned with respect to the patterns of signals generated from the variety of tap motions.

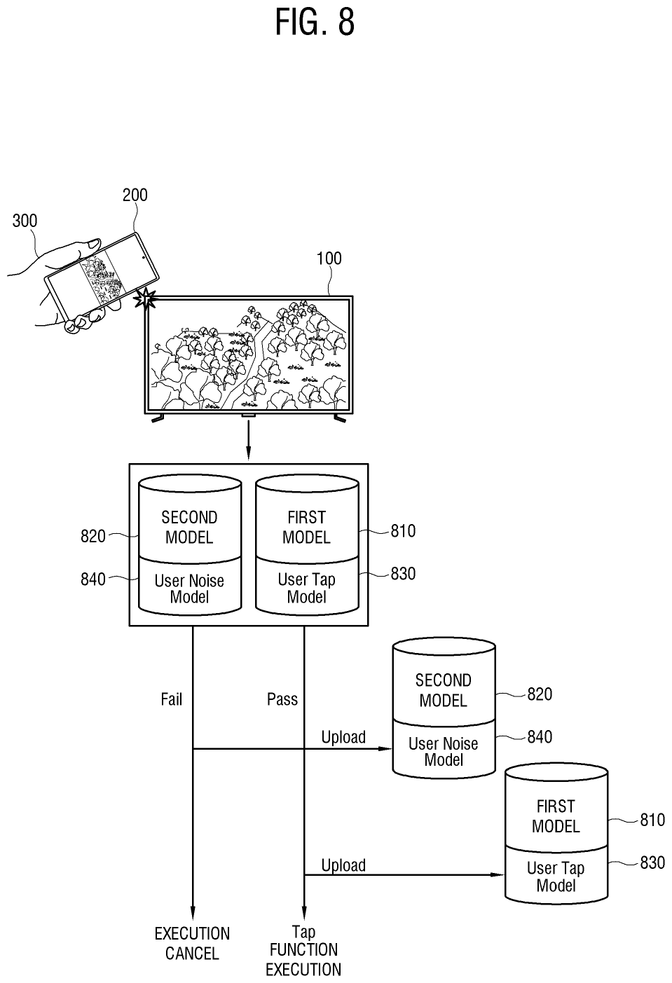

FIG. 8 is a view showing an operation of the electronic apparatus according to an embodiment. The electronic apparatus 100 shown in FIG. 8 directly learns detected signals to generate new models and updates the generated models therein, rather than using models prepared in advance or receiving models from the outside.

The models according to the embodiment may be prepared as a default (i.e., an initial state) and stored in advance, or received and stored from the outside. The models according to the embodiment may include, for example, a first model 810 for identifying a tap motion, and a second model 820 for identifying a noise. Here, the two models 810 and 820 are not required to be always used together and the second model 820 may be optionally provided. If the second model 820 is provided, in addition to identifying whether the signal detected using the first model 810 is the tap motion, the electronic apparatus may additionally identify whether the detected signal is a signal corresponding to the noise, thereby further increasing reliability.

If the pattern corresponding to the pattern of the signal detected through the sensor 170 corresponds to a reference pattern in the first model 810 (Pass in FIG. 8), the processor 180 may identify the detected signal as a signal corresponding to a user event. If the pattern of the detected signal does not correspond to a pattern in the first model 810, the processor 180 may identify the detected signal as a signal not corresponding to the user event. Here, the processor 180 may identify the detected signal as the signal corresponding to the noise. If a reference pattern corresponding to the pattern of the detected signal is not in the first model 810 (Fail in FIG. 8), the processor 180 may identify whether the pattern of the detected signal corresponds to a reference pattern in the second model 820 to identify whether the detected signal is the signal corresponding to the noise. As another example, the processor 180 may first apply the second model 820 from among the first model 810 and the second model 820. For example, if the detected signal corresponds to a reference pattern in the second model 820, the processor 180 may identify the detected signal as the noise. At this time, the processor 180 may identify that the detected signal is not the user event, and stop the identification operation using the first model 810. Like this, the processor 180 may perform the operation identifying whether the signal detected in various forms using the first model 810 and the second model 820 is the user event. The processor 180 may identify whether the detected signal is the user event, by identifying whether the sensing value detected by the sensor 170 exceeds threshold values or whether waveforms of the sensing values follow a pattern as shown in FIG. 5.

According to an embodiment, if a reference pattern corresponding to the pattern of the detected signal is not in the first model 810, the processor 180 may add a model of a new reference pattern corresponding to the pattern of the detected signal. Through the updating process as above, the processor may obtain a user tap model 830. The user tap model 830 may be used to identify the reference patterns corresponding to the patterns of the detected signals.

According to another embodiment, if a reference pattern corresponding to the pattern of the detected signal is not in the first model 810, the processor 180 may identify whether the detected signal is a signal of the new reference pattern corresponding to the user event using additional information about the detected signal. The additional information may be obtained by receiving user inputs indicating user events, information capable of recognizing the external apparatus, or the like, by the processor 110 via the interface 110. If it is identified that the detected signal is the signal of the new reference pattern corresponding to the user event using the additional information, the processor 180 may generate a model of a new reference pattern corresponding to the pattern of the detected signal, and add the generated model to the user tap model 830. If it is identified that the detected signal is not the signal of the new reference pattern corresponding to the user event using the additional information, the processor 180 may not generate the model of the new reference pattern corresponding to the pattern of the detected signal. Accordingly, the processor 180 may clearly identify whether the detected signal is the signal of the new reference pattern corresponding to the user event, thereby increasing reliability.

According to another embodiment, if a reference pattern corresponding to the pattern of the detected signal is not in the first model 810, the processor 180 may identify whether the pattern of the detected signal corresponds to a reference pattern in the second model 820 again to identify whether the detected signal is a signal corresponding to the noise. If it is identified that the detected signal is the signal corresponding to the noise, the processor 180 may not generate a model of a new reference pattern corresponding to the pattern of the detected signal. If it is identified that the detected signal is not the signal corresponding to the noise, the processor may generate the model of the new reference pattern corresponding to the pattern of the detected signal and add the generated model to the user tap model 830. Accordingly, if the detected signal does not correspond to the first model 810, the processor may identify whether the detected signal is the signal corresponding to the noise and then update the model, thereby further increasing reliability.

If it is identified that the detected signal is not the signal corresponding to the noise, the processor 180 may identify whether the detected signal is a signal of the new reference pattern corresponding to the user event using additional information about the detected signal. If it is identified that the detected signal is the signal of the new reference pattern corresponding to the user event using the additional information, the processor 180 may generate a model of a new reference pattern corresponding to the pattern of the detected signal, and add the generated model to the user tap model 830.

If it is identified that the detected signal is not the signal of the new reference pattern corresponding to the user event using the additional information, the processor 180 may not generate the model of the new reference pattern corresponding to the pattern of the detected signal. In this case, the processor 180 may identify whether the detected signal is a signal corresponding to the noise using the additional information. If it is identified that the detected signal is the signal corresponding to the noise, the processor 180 may generate a model of a new reference pattern corresponding to the pattern of the detected signal and add the generated model to a user noise model 840. The user noise model 840 may be used to identify whether the detected signal is the signal corresponding to the noise. According to an exemplar, by continuing to train a model through the update process, a model that gradually meets needs of the user may be obtained, thereby further increasing recognition rate between apparatuses.

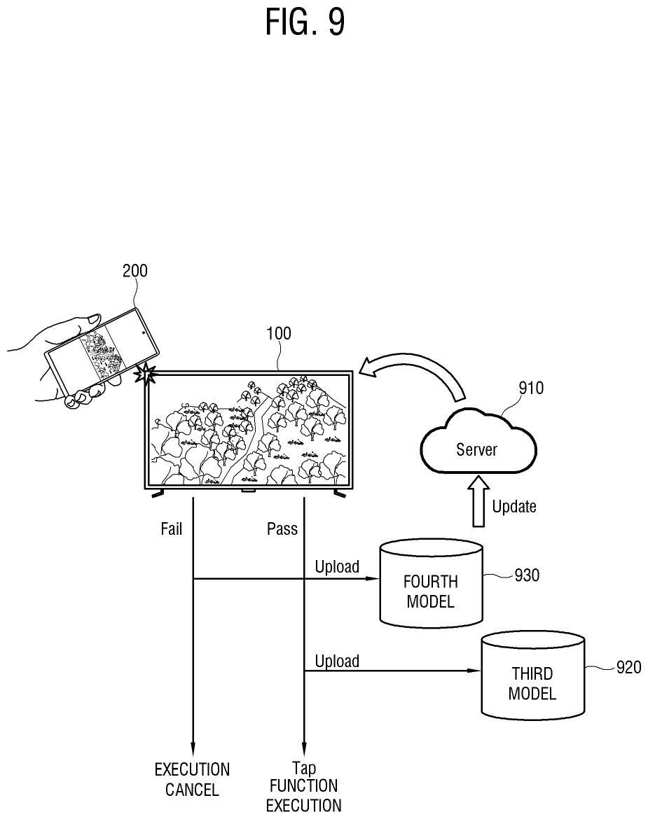

FIG. 9 is a view showing an operation of the electronic apparatus according to an embodiment. The electronic apparatus 100 shown in FIG. 9 is configured to use a model provided in advance or received from the outside, and update the model at a server 910.

The model of an embodiment may include, as an example, a third model 920 for identifying the tap motion, and a fourth model 930 for identifying the noise. Here, the fourth model 930 may or may not be provided according to embodiments.

In FIG. 9, the processor 180 may receive information of the model from the server 910 via the interface 110, and based on the received information of the model, identify whether the pattern of the detected signal corresponds to a reference pattern in the model.

According to an embodiment, if the pattern of the detected signal corresponds to a reference pattern in the third model 920, the processor 180 may perform an operation corresponding to a user event. If a reference pattern corresponding to the pattern of the detected signal is not in the third model 920, the processor 180 may generate a model of a new reference pattern corresponding to the pattern of the detected signal and transmit the model to the server 910 via the interface 100 to add the model to the third model 920.

According to another embodiment, if a reference pattern corresponding to the pattern of the detected signal is not in the third model 920, the processor 180 may identify whether the detected signal is a signal of the new reference pattern corresponding to the user event using additional information about the detected signal. If it is identified that the detected signal is the signal of the new reference pattern corresponding to the user event using additional information, the processor 180 may generate a model of a new reference pattern corresponding to the pattern of the detected signal, and transmit the generated model to the server 910 via the interface 110 to add the model to the third model 920. If it is identified that the detected signal is not the signal of the new reference pattern corresponding to the user event using the additional information, the processor may not generate the model of the new reference pattern corresponding to the pattern of the detected signal. This object is for clearly identifying whether the detected signal is a signal generated from the signal of the new reference pattern corresponding to the user event, thereby increasing reliability.

According to another embodiment, if the detected signal does not correspond to a pattern in the third model 920, the processor 180 may identify whether the detected signal corresponds to a reference pattern in the fourth model 930 again to identify whether the detected signal is a signal corresponding to a noise. If it is identified that the detected signal is the signal corresponding to the noise, the processor 180 may not generate a model of a new reference pattern corresponding to the pattern of the detected signal. If it is identified that the detected signal is not the signal corresponding to the noise, the processor may generate the model of the new reference pattern corresponding to the pattern of the detected signal and transmit the generated model to the server 910 via the interface 100 to add the model to the third model 920. Thus, if the detected signal does not correspond to the third model 920, it may be identified whether the detected signal is the signal corresponding to the noise and the model may then be updated, thereby increasing reliability.

If it is identified that the detected signal is not the signal corresponding to the noise, the processor 180 may identify whether the detected signal is a signal of the new reference pattern corresponding to the user event using additional information about the detected signal. If it is identified that the detected signal is the signal of the new reference pattern corresponding to the user event using the additional information, the processor 180 may generate a model of a new reference pattern corresponding to the pattern of the detected signal, and transmit the generated model to the server 910 via the interface 110 to add the model to the third model 910.

If it is identified that the detected signal is not the signal of the new reference pattern corresponding to the user event using the additional information, the processor 180 may not generate the model of the new reference pattern corresponding to the pattern of the detected signal. In this case, the processor 180 may identify whether the detected signal is the signal corresponding to the noise using the additional information. If it is identified that the detected signal is the signal corresponding to the noise, the processor 180 may generate the model of the new reference pattern corresponding to the pattern of the detected signal and transmit the generated model to the server 910 via the interface 100 to add the model to the fourth model 930.

According to an embodiment, it is possible to use and update the learned model even through the server, not the electronic apparatus, thereby increasing convenience of the user and overcoming limitations of the processor.

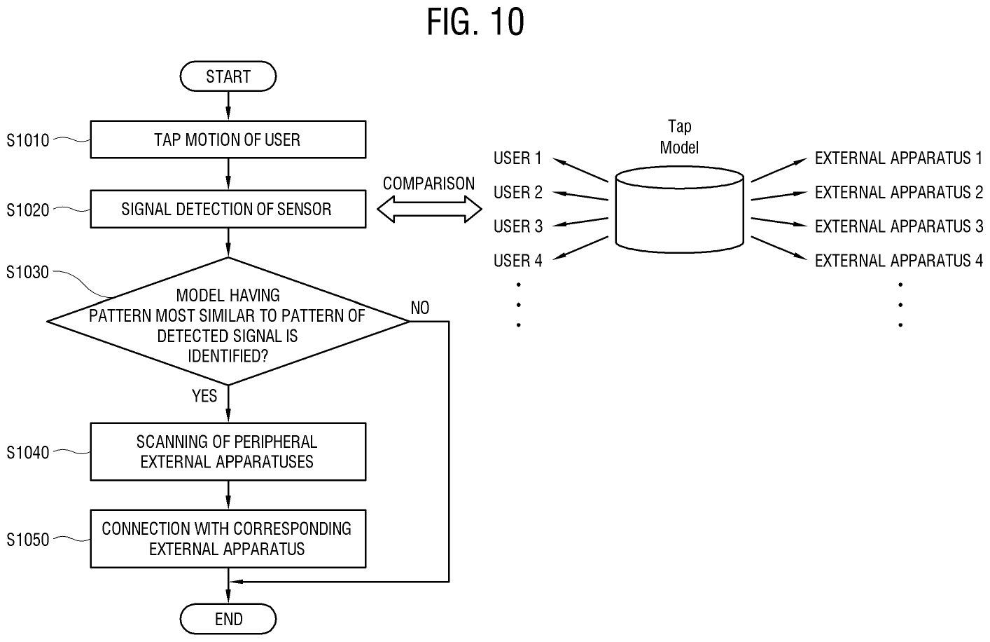

FIG. 10 is a flow chart showing an operation of the electronic apparatus according to an embodiment. For example, the operation may be performed by the electronic apparatus 100 that has a plurality of models according to different users and/or external apparatuses. As discussed above, if the user makes a tap motion to the electronic apparatus 100 using the external apparatus (S1010), the sensor 170 may detect a signal (S1020).

If a signal corresponding to a user event is identified, the electronic apparatus 100 identifies, as a next operation, an external apparatus by which the user event is generated to connect the electronic apparatus 100 with the external apparatus.

According to an embodiment, the processor 180 may use models in which a plurality of reference patterns corresponding to users and/or external apparatuses is learned according to the users and/or the external apparatuses, as a plurality of models. For example, as shown in FIG. 10, the plurality of learned models may exist corresponding to the users (i.e., a user 1, a user 1, a user 3, . . . ), and exist corresponding to the external apparatuses (i.e., an external apparatus 1, an external apparatus 2, an external apparatus 3, . . . ). The processor 180 may control storage of patterns of signals detected in processes connecting the electronic apparatus 100 with the external apparatuses and corresponding information about connected users or external apparatuses, and generate a plurality of models while repeating the processes. However, that is only an embodiment, and the models learned by the method described in FIG. 6 may be also obtained.

Accordingly, based on the reference patterns of the plurality of models provided being learned according to the plurality of users and/or external apparatuses, the processor 180 may identify user events with greater reliability. The processor 180 may compare the pattern of the detected signal and the patterns of the plurality of models provided according to the plurality of users and/or external apparatuses to identify any one model having a reference pattern most similar to the pattern of the detected signal from among the plurality of models (S1030). If there is any one model having the most similar reference pattern (Yes in S1030), the processer 180 identifies that a user event, which may correspond to a user or an external apparatus, corresponding to the identified model has occurred. And then, the processor 180 may scan peripheral users or external apparatuses (S1040). The processor 180 may scan the peripheral users using the image sensing or the like as described above. If scanning the external apparatuses, the processor 180 may transmit, for example, BLE signals in a broadcast manner to the external apparatuses, receive signals responding thereto from the external apparatuses, and analyze identification numbers or the like of the external apparatuses included in the received signal to identify connectable external apparatuses. The processor may compare information about the scanned users or the external apparatuses with information about the user or the external apparatus stored corresponding to the identified model to connect the electronic apparatus 100 with corresponding external apparatus 200 (S1050), and perform an operation of transmitting a content between the connected apparatuses.

In another embodiment, if patterns of signals detected in processes connecting the electronic apparatus 100 with the external apparatuses are stored in association with information about connected users or external apparatuses, the processor 180 of the electronic apparatus 100 may skip the operation of scanning the external apparatuses, and perform the connecting operation right away. If identification information of the external apparatus corresponding to the signal of the reference pattern similar to the detected signal is pre-stored in the storage 140, the processor 180 may skip the operation of transmitting and receiving the information for identifying whether the user event occurs using the broadcasting scan, and perform the operation of connecting with the external apparatus using the pre-stored identification information of the external apparatus right away. Accordingly, connection speed between apparatuses may be further improved.

However, if there is no model having the most similar reference pattern (No in S1030), the processer 180 may identify that the user event corresponding to the detected signal has not occurred, and not perform the follow-up operation. As another embodiment, even though there is no model having the most similar reference pattern, the processor 180 may scan peripheral users or external apparatuses (S1040), and connect with the external apparatus by which the user event is generated based on information about the scanned users or external apparatuses and additional information about relevance between the detected signals, user intentions, etc. (S1050).

According to an embodiment, the models learned according to the users and/or external apparatuses are provided, thereby increasing speed of recognizing the users and/or the external apparatuses and enhancing accuracy and reliability of connection between the apparatuses.

While embodiments have been described in detail, it will be understood by one of ordinary skill in the art that various changes in form and details may be made therein without departing from the spirit and scope of the disclosure as defined by the following claims.

1. An electronic apparatus comprising:
an interface;
a sensor; and
a processor configured to:
identify whether a pattern of a signal generated by the sensor corresponds to any of a plurality of reference patterns,
based on the pattern corresponding to a reference pattern from among the plurality of reference patterns, identify an external apparatus corresponding to the reference pattern, and
perform establish a connection between the identified external apparatus and the electronic apparatus through the interface.

2. The electronic apparatus according to claim 1, wherein the processor is further configured to, based on a plurality of models learned to identify characteristics of the plurality of reference patterns different from each other, identify whether the pattern of the signal corresponds to the reference pattern.

3. The electronic apparatus according to claim 2, wherein the processor is further configured to identify whether the pattern of the signal corresponds to the reference pattern based on similarities between the pattern of the signal and normalized characteristics of reference patterns of the plurality of models.

4. The electronic apparatus according to claim 2, wherein the processor is further configured to generate a model of a new reference pattern corresponding to the pattern of the signal based on identifying the pattern of the signal does not correspond to any of the plurality of reference patterns.

5. The electronic apparatus according to claim 2, wherein the processor is further configured to:
control the electronic apparatus to receive information about the plurality of models from a server, and
identify whether the pattern of the signal corresponds to the reference pattern based on the information received about the plurality of models.

6. The electronic apparatus according to claim 1, wherein the plurality of reference patterns respectively correspond to a plurality of external apparatuses, and
wherein the processor is further configured to:
identify the external apparatus corresponding to the pattern of the signal from among the plurality of external apparatuses, and
transmit content corresponding to the external apparatus.

7. The electronic apparatus according to claim 1, wherein the plurality of reference patterns respectively correspond to a plurality of users, and
wherein the processor is further configured to:
identify a user corresponding to the pattern of the signal from among the plurality of users, and
transmit content corresponding to the user to the external apparatus.

8. The electronic apparatus according to claim 1, wherein the plurality of reference patterns comprises a first plurality of reference patterns corresponding to user events and a second plurality of reference patterns corresponding to noise, and
wherein the processor is further configured to:
identify whether the pattern of the signal corresponds to any of the first plurality of reference patterns, and
based on the pattern of the signal not corresponding to any of the first plurality of reference patterns, identify whether the pattern of the signal corresponds to any of the second plurality of reference patterns.

9. The electronic apparatus according to claim 8, wherein the processor is further configured to, based on a plurality of models learned to identify characteristics of the second plurality of reference patterns different from each other, identify whether the pattern of the signal corresponds to the second plurality of reference patterns.

10. The electronic apparatus according to claim 8, wherein the processor is further configured to, based on identifying the pattern of the signal does not correspond to any of the first plurality of reference patterns and does not correspond to any of the second plurality of reference patterns, add a model of a new reference pattern corresponding to the pattern of the signal.

11. The electronic apparatus according to claim 1, wherein each of the plurality of reference patterns have characteristics different from each other indicative of a user from among a plurality of users.

12. The electronic apparatus according to claim 1, wherein the processor is further configured to control transmission of a content to the external apparatus through the connection.

13. The electronic apparatus according to claim 12, wherein the processor is further configured to identify the content from among a plurality of contents based on the pattern of the signal.

14. A control method of an electronic apparatus, comprising:
identifying whether a pattern of a signal generated by a sensor of the electronic apparatus corresponds to any of a plurality of reference patterns;
based on the pattern corresponding to a reference pattern from among the plurality of reference patterns, identifying an external apparatus corresponding to the reference pattern; and
establishing a connection between the identified external apparatus and the electronic apparatus through an interface of the electronic apparatus.

15. The control method according to claim 14, wherein the identifying whether the pattern of the signal corresponds to any of the plurality of reference patterns comprises, identifying whether the pattern of the signal corresponds to any of the plurality of reference patterns based on a plurality of models learned to identify characteristics of the plurality of reference patterns which differ from each other.

16. The control method according to claim 15, wherein the identifying whether the pattern of the signal corresponds to any of the plurality of reference patterns comprises identifying whether the pattern of the signal corresponds to any of the plurality of reference patterns based on similarities between the pattern of the signal and normalized characteristics of reference patterns of the plurality of models.

17. The control method according to claim 14, further comprising adding a model of a new reference pattern corresponding to the pattern of the signal based on the pattern of the signal not corresponding to any of the plurality of reference patterns.

18. A non-transitory computer readable recording medium having embodied thereon a program, which when executed by a processor of an electronic apparatus causes the electronic apparatus to execute a method that includes:
identifying whether a pattern of a signal generated by a sensor of the electronic apparatus corresponds to any of a plurality of reference patterns;
based on the pattern corresponding to a reference pattern from among the plurality of reference patterns, identifying an external apparatus corresponding to the reference pattern; and
establishing a connection between the identified external apparatus and the electronic apparatus through an interface of the electronic apparatus.

19. An electronic apparatus comprising:
an interface;
a sensor;
a memory configured to store a first content and a second content; and
a processor configured to:
identify whether a pattern of a signal generated by the sensor corresponds to any of a plurality of reference patterns,
based on the pattern corresponding to a first reference pattern from among the plurality of reference patterns, transmit the first content to a first external apparatus through the interface, and
based on the pattern corresponding to a second reference pattern from among the plurality of reference patterns, transmit the second content to a second external apparatus through the interface.

20. The electronic apparatus according to claim 19, wherein the processor is further configured to:
based on the pattern corresponding to the first reference pattern, establish a connection with the first external apparatus through the interface, and
based on the pattern corresponding to the second reference pattern, establish the connection with the second external apparatus through the interface.

21. The electronic apparatus according to claim 19, wherein each of the plurality of reference patterns indicates a reference intensity and a reference number of peaks.

22. The electronic apparatus according to claim 21, wherein the processor is further configured to compare a number of peaks in the signal generated by the sensor with the reference number of peaks in each of the plurality of reference patterns to identify whether the pattern of the signal corresponds to any of the plurality of reference patterns.

23. The electronic apparatus according to claim 22, wherein the processor is further configured to compare an intensity of the signal generated by the sensor with the reference intensity of the plurality of reference patterns to identify whether the pattern of the signal corresponds to any of the plurality of reference patterns.

24. An electronic apparatus comprising:
a display panel;
an interface;
a sensor; and
a processor configured to:
identify whether a pattern of a signal generated by the sensor corresponds to any of a plurality of reference patterns,
based on the pattern corresponding to a first reference pattern from among the plurality of reference patterns, establish a connection with a first external apparatus through the interface and control the display panel to display first information received from the first external apparatus through the interface, and
based on the pattern corresponding to a second reference pattern from among the plurality of reference patterns, establish the connection with a second external apparatus through the interface and control the display panel to display second information received from the second external apparatus through the interface.

25. The electronic apparatus according claim 24, wherein the processor is further configured to perform a screen mirroring operation based on the first information received from the first external apparatus or the second information received from the second external apparatus through the interface.
